(19) United States
(12) Patent Application Publication
(10) Pub. No.: US 2007/0193009 A1
(43) Pub. Date: Aug. 23, 2007

(54) Method and apparatus for continuous manufacture of battery grids

(76) Inventors: Albert M. Vincze, Oakville (CA); John V. Marlow, Oakville (CA)

Correspondence Address: Arne I. Fors;Growling Lafleur Henderson LLP, Suite 1600, 1 First Canadian Place, 100 King Street West, Toronro, ON, M5X 1G5, US

(21) Appl. No.: 11/707,085

(22) Filed: Feb. 16, 2007

Related U.S. Application Data
(60) Provisional application No. 60/775,340, filed on Feb. 22, 2006.

(51) Int. Cl. H01M 4/82; H01M 4/74

(52) U.S. Cl. 29/2; 429/241

(57) ABSTRACT

A method and apparatus for continuous, high-speed production of strip having an array of high-tolerance closely-spaced holes forming a continuous grid structure having wires bent out of the plane of the grid. The strip can be produced by continuous casting, extruding or by rolling reduction methods and the holes can be formed such as by linear punching and rotary punching. An apparatus for rotary punching comprises a first pair of opposed rotary dies, one a female die and the other a male/female die, which punches a first set of holes in a strip fed continuously between the dies, and a second pair of opposed rotary dies, one the male/female die and the other a male die, which punches a second set of holes in the strip between the first set of holes defining a continuous grid structure having grid wires, the strip being wrapped about the common male/female die during punching of the first and second sets of holes to continuously index the strip with the two opposed pairs of rotary dies to ensure production of the high-tolerance closely-spaced holes. A third pair of opposed rotary dies bends the grid wires of the continuous grid structure out of the plane of the grid, preferably symmetrically about the plane of the grid, to provide enhanced paste retention to battery plates manufactured from the grid.

### BACKGROUND OF THE INVENTION

(i) Field of the Invention

This invention relates to the production of battery grids and, more particularly, relates to a method and apparatus for forming an array of holes in deformable strips such as lead strip, such as by continuous punching, for the production of lead or lead alloy grids having grid wires bent out of plane for enhanced paste retention characteristics for use in the manufacture of lead-acid batteries.

(ii) Description of the Related Art

The prior art discloses rotary methods for expanding lead strip for use in the manufacture of battery plates. Such methods employ clusters of tools arranged sequentially for preforming and slitting the strip in a first step and completion of slitting of the strip in a second step. Sequential methods have the inherent problems of synchronization of steps, such as roll-to-roll synchronization, requiring certain registering and tracking considerations.

Wires and nodes on opposite sides of expanded strip produced by the stretching and forming according to the prior art are not uniform and are not symmetrical. The profile and shape on one side is not the mirror image of the other side resulting in a number of imperfections and defects. This becomes even more significant when higher elongation targets are desired in order to produce lighter grid electrodes for batteries.

Cominco U.S. Pat. No. 4,291,443 issued Sep. 29, 1981 and U.S. Pat. No. 4,315,356 issued Feb. 16, 1982, both incorporated herein by reference, disclose the geometric relationship of conventional 3-shaft cluster tooling or spaced-apart roll pairs employing two sequential steps, i.e. preforming, wherein the lead strip is slit and stretched to form wires that are still solidly connected and not in a form to be pulled apart, and slitting, wherein alternate slits in the nodes are made to allow subsequent expansion to complete the process.

Cominco U.S. Pat. No. 4,297,866 issued Nov. 3, 1981, also incorporated herein by reference, discloses a sequential two-step process for the production of symmetrical slit wires deformed out of the plane of the strip having a trailing portion of the wire longer than the leading portion for improved stretchability of the wires.

Teck Cominco U.S. Pat. No. 6,691,386 issued Feb. 19, 2004, also incorporated herein by reference, discloses a one-step process which overcomes the aforementioned problems of synchronization of steps and related imperfections and defects.

Battery grids produced by slitting and expansion of strip to form expanded metal mesh provide enhanced battery paste retention due to inherent twisting of grid wires.

The production of battery grids from continuous strip by punching of holes is an alternative to slitting and expansion of strip, but problems have been encountered in multi-stage punching to produce a grid having closely-spaced holes or spaces defining a lattice structure comprised of grid wires intersecting at nodes.

Conventional non-rotary punching of strip for the production of mesh for battery grids has addressed the problem of punching many closely spaced, small holes. The successful methods employ a reciprocating punch that stamps one large section of grid at a time, and then indexes the deformable strip downstream before stamping another section of the grid. This segmented approach is production-rate limiting and is relatively slow compared to rotary punching because the process is stop-and-go as opposed to continuous. These reciprocating punch presses must be robust and powerful to punch metal and the constant change in momentum due to machine oscillation creates problems with noise, precision and vibration. Indexing the strip between punches can also result in imprecision of hole placement between one set of punched holes and the next.

Indexing also has a down-stream effect on the production of mesh from lead strip because it causes a jerky motion in the movement of the lead strip. This can possibly damage the lead mesh or make it difficult to smoothly integrate the mesh into the next phase of processing.

Rotating punches that have been applied to the metal industry often rely on the shearability of a metals like steel and aluminium which do not deform plastically as much as lead and other soft materials. Even when using steel and aluminium, these rotary punches often leave burs and unclean or ragged cuts, which can result in an unacceptable accumulation of errors.

U.S. Pat. No. 7,066,066 issued Jun. 27, 2006 to Teck Cominco Metals Ltd., incorporated herein by reference, discloses a method and apparatus for continuous, high-speed production of punched strip for forming a grid having grid wires for battery grids of lead-acid storage batteries. The grid wires form a rectangular lattice structure having a plurality of equispaced longitudinal grid wires parallel to the long axis of the strip and a plurality of equispaced transverse grid wires intersecting at nodes. The highly effective rectangular structure, is particularly well-suited for continuous, high-speed production by rotary punching compared to cast and linear production methods.

It is an object of the present invention therefore to provide a method and apparatus for continuous punching of deformable strip at high speed to produce a punched grid having a high tolerance, closely spaced array of holes and a grid having grid wires bent out of the plane of the grid for enhanced paste retention. It is another object of the invention to provide two-stage rotary punch apparatus which is self-indexing for high speed production of a uniformly punched grid. Another object of the invention is the provision of a rotary punching and grid wire bending machine for producing battery grids for lead-acid batteries.

Increased electrical current collection capability and increased tensile strength from the bottom to the top of each grid lattice for use as a battery plate, in proximity to the plate tab, and improved corrosion resistance are desirable battery plate characteristics. U.S. Pat. No. 6,797,403 issued Sep. 28, 2004 to Teck Cominco Metals Ltd., incorporated herein by reference, discloses a method of producing lead alloy strip for fabrication of positive and negative electrodes of a lead-acid battery by extruding a lead alloy at elevated temperature to produce a lead alloy strip having a desired profile and rapidly cooling the extruded strip to acquire a desired microstructure. Battery grids produced by extrusion from lead alloy strip have reduced vertical growth and enhanced resistance to corrosion, good electrical conductivity and with desired profiles such as tapered, thin and lightweight profiles. It is a further object of the present invention therefore to provide a grid lattice structure for battery plates with a controlled profile including tapered profiles and lightweight and thin profiles having enhanced electrical current collection capability, increased structural strength and corrosion resistance, which can be produced such as by extrusion followed by high-speed rotary punching.

A preferred direction in the battery industry is to provide battery grids which are thinner and lighter in weight, while maintaining strength and electrical conductivity with enhanced paste retention. It is an object of the invention therefore to provide thin, lightweight battery grids produced from continuously cast, extruded or rolled strip having enhanced paste adhesion and retention.

Paste retention is a major problem in battery grids produced by punching of strip. It is therefore a principal object of the present invention to provide a punched grid array of closely-spaced holes which has a grid lattice which projects out of the plane of the grid to enhance paste retention.

### SUMMARY OF THE INVENTION

In its broad aspect, the method of the present invention for making battery grids for supporting battery paste comprises providing a length of lead or lead alloy strip having a width defined by a pair of equispaced side edges; forming an elongated array of closely-spaced holes in the strip defining a grid having a plurality of equispaced longitudinal grid wires parallel to the strip side edges across at least a portion of the width of the lead alloy strip and a plurality of transverse grid wires extending across the grid from one side to the other side of the grid intersecting the longitudinal grid wires at nodes, and bending the grid wires intermediate the nodes out of the plane of the grid for enhanced paste retention to the grid. The transverse grid wires are bent out of the plane of the grid, preferably symmetrically about the plane of the grid, in proximity to the grid sides and in proximity to the nodes. Alternating transverse grid wires can be bent in opposite directions out of the plane of the grid along the length of the grid, across the width of the grid, or along the length of the grid and across the width of the grid. The transverse grid wires are bent out of the plane of the grid at least 0.1 millimetre, up to the thickness of the grid, from each side of the grid, at an angle of at least about 5° to the plane of the grid, preferably at an angle of about 5° to 45° and more preferably at an angle of 15° to 35° to the plane of the grid.

The array of closely-spaced holes are formed in the strip such as by punching strip material out of the lead alloy strip by a first pair of opposed rotary dies consisting of a female die and a male/female die and a second pair of opposed rotary dies consisting of a said male/female die and a male die comprising continuously feeding the length of strip to the first pair of opposed rotary dies for punching a first set of closely-spaced holes transversely of the strip along the strip, continuously feeding the strip to the second pair of dies for punching a second set of holes in the strip between the first set of holes defining the grid having grid wires, the strip being wrapped about the common male/female die during punching of the first and second sets of holes to continuously index the strip with the two opposed pairs of rotary dies to ensure production of higher-tolerance closely-spaced holes, and bending the grid wires out of the plane of the grid.

The transverse grid wires are bent out of the plane of the grid, preferably symmetrically, by passing the strip through a pair of opposed rolls having angularly-spaced alternating projections and recesses of one roll for mating with angularly-spaced alternating recesses and projections of the other roll, whereby the transverse grid wires are displaced into the recesses of the rolls for bending of the transverse grid wires out of the plane of the grid. The transverse grid wires are bent symmetrically out of the plane of the grid in proximity to the grid side edges and in proximity to the nodes along the length of the lead alloy strip, across the width of the lead alloy strip, or along the length of the grid and across the width of the grid.

A lug is formed in the strip adjacent one side of the grid and the grid may be tapered from a longitudinal side edge remote from the lug towards the lug whereby electrical conductivity in the grid is enhanced in proximity to the lug. In another embodiment, the grid has thickened longitudinal edges or transverse grid wires may have an increasing width from the longitudinal edge remote from the lug towards the lug.

In another aspect of the invention, the method of the invention relates to a method of making battery plates comprising providing a length of lead alloy strip having a width defined by a pair of equispaced side edges; forming equispaced elongated arrays of closely-spaced holes in the strip defining grids having a plurality of equispaced longitudinal grid wires parallel to the side edges across at least a portion of the width of the lead alloy strip and a plurality of transverse grid wires extending across the grid and intersecting the longitudinal grid wires at nodes, and bending the grid wires intermediate the nodes out of the plane of the grid for enhanced paste retention to the grid; applying paste to the grids formed in the lead alloy strip, and cutting the pasted strip to form pasted battery plates. Preferably, a pair of elongated parallel arrays of closely-spaced holes are formed in the strip, each array of holes defining a said grid in proximity to a strip side edge separated from an adjacent grid by a longitudinal, central blank section, forming grid lugs in the central blank section, applying paste to the grids, and severing the pasted grids into battery plates.

### BRIEF DESCRIPTION OF THE DRAWINGS

These and other objects of the invention can be attained by the method and apparatus of the invention illustrated in the accompanying drawings, in which:

FIG. 1 is a perspective view of a first embodiment of a battery grid of the present invention;

FIG. 2 is a front plan view thereof;

FIG. 3 is a rear plan view thereof;

FIG. 4 is an end elevational view thereof;

FIG. 5 is a top view thereof;

FIG. 6 is a bottom view thereof;

FIG. 7 is an opposite end view of FIG. 4;

FIG. 8 is a perspective view of another embodiment of the battery grid of the invention;

FIG. 9 is an enlarged view of a portion of the embodiment shown in FIG. 8;

FIG. 10 is an enlarged view of a portion of further embodiment;

FIG. 11 is an enlarged view of a portion of an elliptical embodiment of the invention;

FIG. 12 is an end view of another embodiment having a uniformly thick cross-section;

FIG. 13 is an end view of a further embodiment having thick top and bottom sections with a thin lightweight central section;

FIG. 14 is an end view of a still further embodiment having a tapered cross-section;

FIG. 15 is a flowsheet showing the steps of the method of the present invention;

FIG. 16 is a side elevation of a two-stage, indexed, rotary punching assembly;

FIG. 17 is an enlarged side elevation of the assembly shown in FIG. 16,

FIG. 18 is a side schematic view of the assembly shown in FIGS. 16 and 17 in series with a grid wire bender of the invention;

FIG. 19 is a perspective view, partly cut away, of the grid wire bender of the invention;

FIG. 20 is a perspective view depicting an opened wire bender illustrating alternating projections and recesses for forming the embodiment of grid shown in FIGS. 1-7;

FIG. 21 is an exploded front view, partly cut away, of opposed rolls having mating projections and recesses of the embodiment illustrated in FIG. 22;

FIG. 22 is a perspective view of a further embodiment of a battery grid of the invention;

FIG. 23 is a perspective view of another embodiment of the battery grid of the invention;

FIG. 24 is a vertical section of the battery grid taken along line 24-24 of FIG. 22;

FIG. 25 is an end elevation of the battery grid of FIG. 22; and

FIG. 26 is an end elevation of the battery grid of FIG. 23.

### DESCRIPTION OF THE PREFERRED EMBODIMENTS

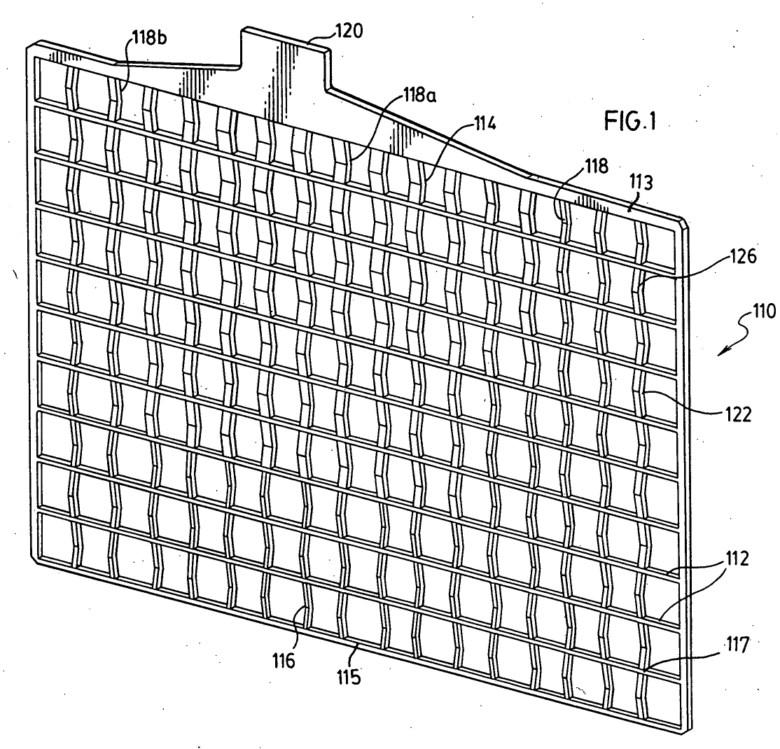

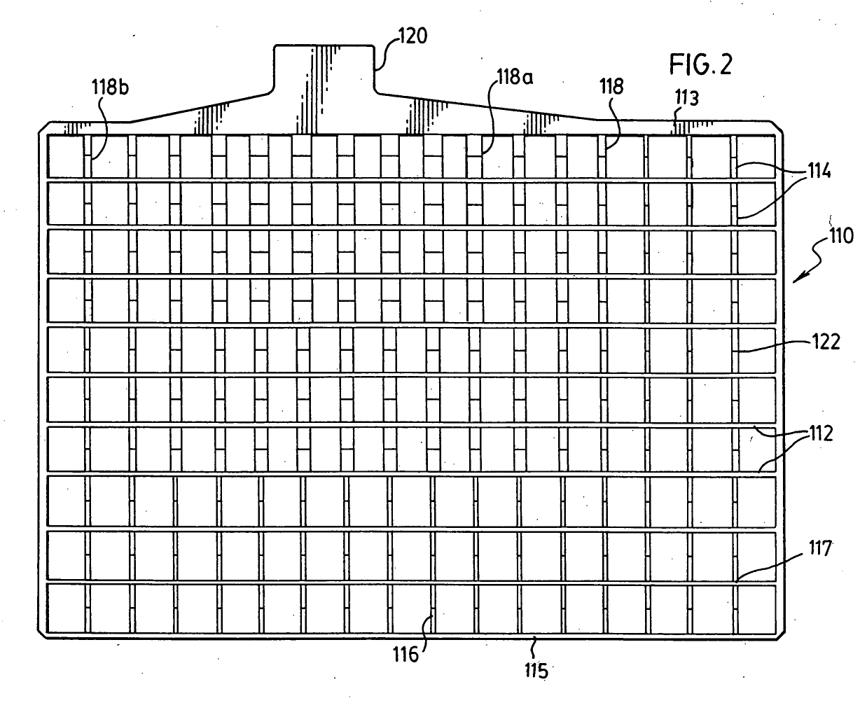

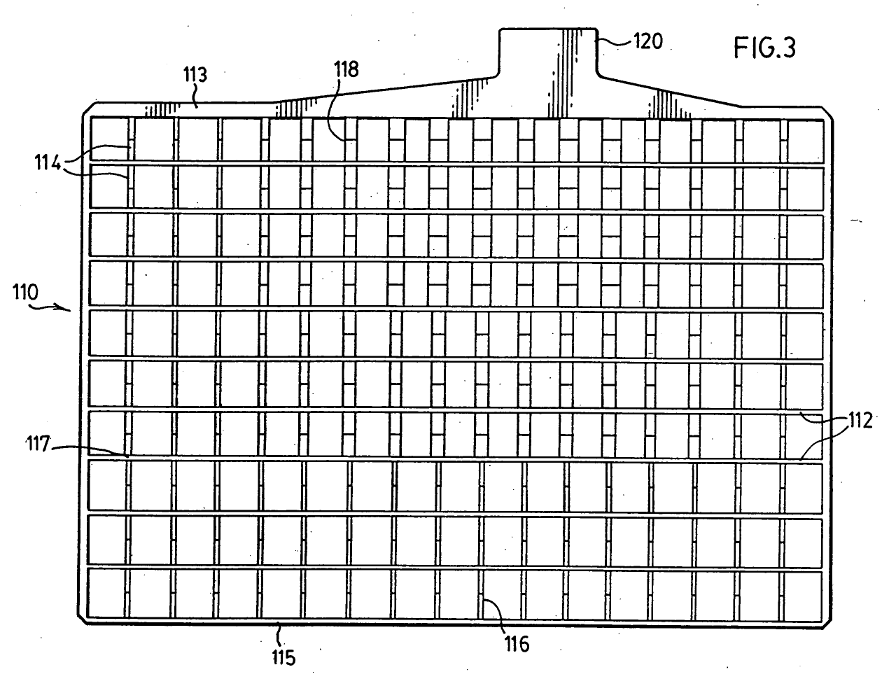

With reference first to FIGS. 1-14, various embodiments of battery grids of the invention are illustrated. FIGS. 1-7 show a battery grid 110 having horizontal (longitudinal) grid wires 112 of uniform width and transverse grid wires 114 having the width increase from the bottom grid wire 116 to the top grid wire 118. The transverse wires 118a at the centre portion of the grid 110 have a greater width than the transverse wires 118b towards the perimeter of the grid for enhanced electrical collection and transfer from the bottom of the grid 116 to lug 120. Transverse grid wires 118, 118a, 118b are bent symmetrically out of the plane of the grid 110 as shown most clearly in FIGS. 1 and 4-7. Each of transverse wire 118, 118a, 118b has a V-shaped middle portion 122 bent at the top and bottom side edges 113, 115 and at the nodes 117 at longitudinal grid wires 112 out of the plane of the grid to enhance battery paste retention.

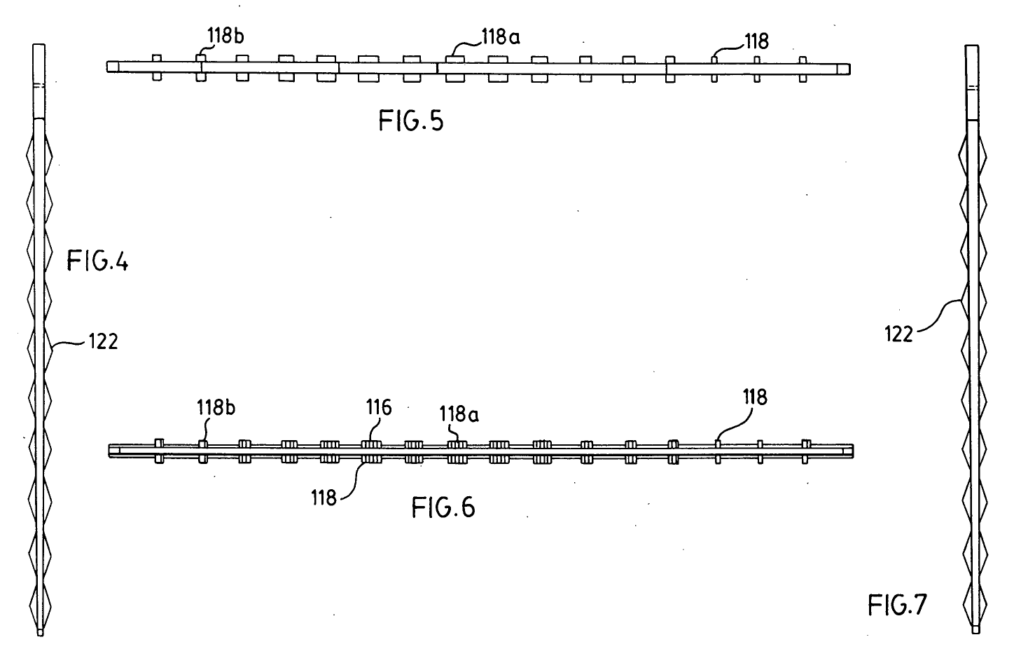

FIGS. 4-7 also illustrate transverse wires 118, 118a, 118b having a taper in thickness increasing from the bottom wire 116 to the top wire 118 of the grid to complement the electrical gathering properties of the transverse wires of the grid.

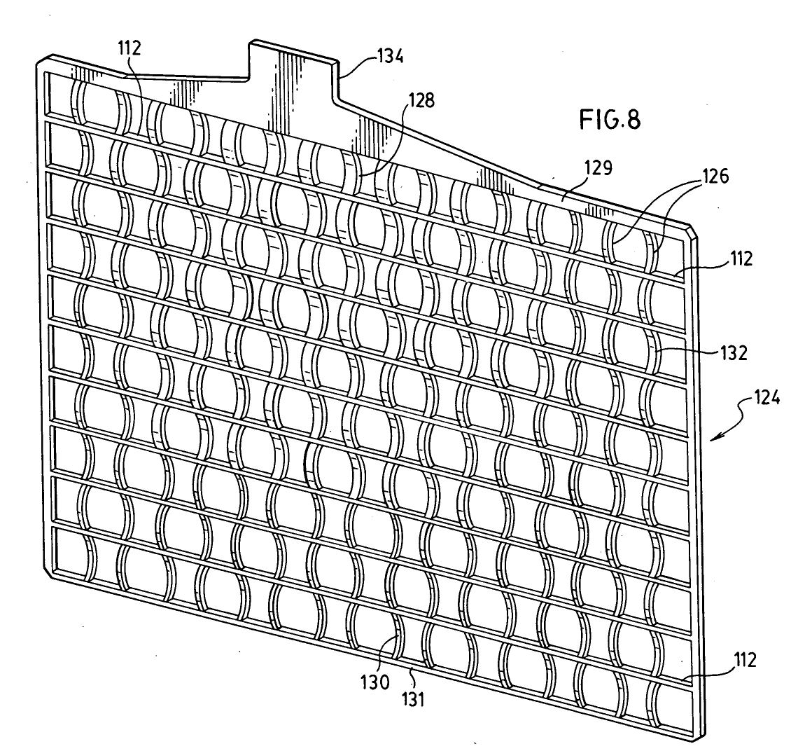

FIG. 8 illustrates a battery grid 124 having curved transverse wire 126 bent symmetrically out of the plane of the grid, transverse grid wires 128 at the upper central portion of the grid having an increased width compared to the bottom transverse wires 130 and side transverse wires 132 for enhanced electrical conductivity to the lug 134. Transverse grid wires 128 and 130 are bent out of the plane of the grid at longitudinal side edges 129 and 131 respectively and at the nodes 133 at longitudinal grid wires 112.

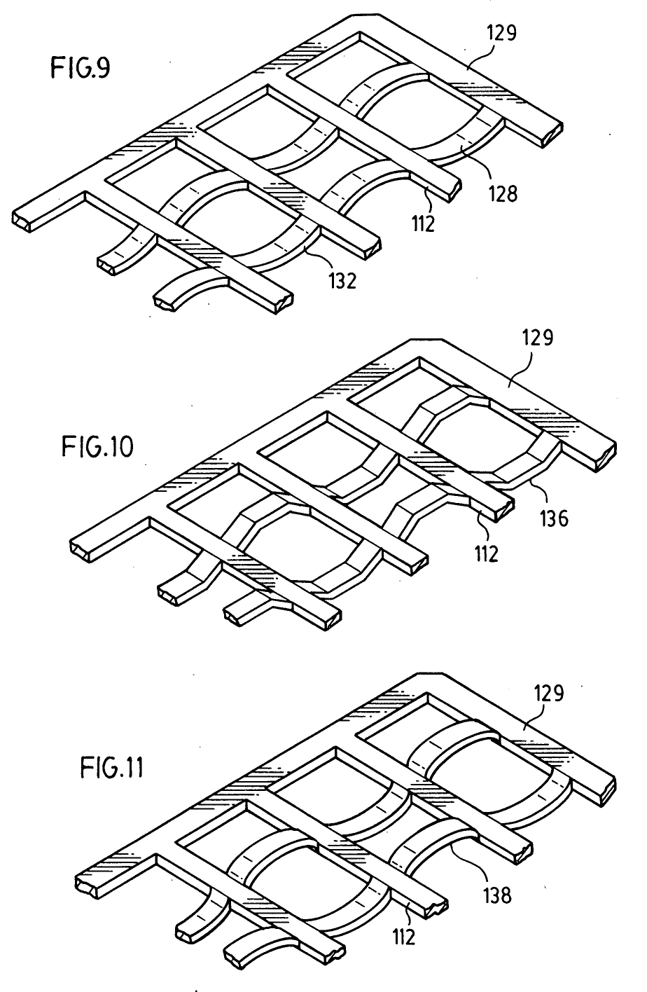

FIG. 9 illustrates a portion of the curved wires 132 of the grid of FIG. 8, FIG. 10 illustrates a portion of a grid having double-bent wires 136, and FIG. 11 illustrates elliptical bent transverse wires 138, all bent symmetrically out of the plane of both sides of the grid.

Alternating transverse grid wires illustrated in FIGS. 8 and 9, 10 and 11 are bent in opposite directions out of the plane of the grid along the length of the grid and across the width of the grid.

Although FIGS. 1-11 show planar longitudinal wires 112, it is understood wires 112 may be bent out of the plane of the grid for paste retention.

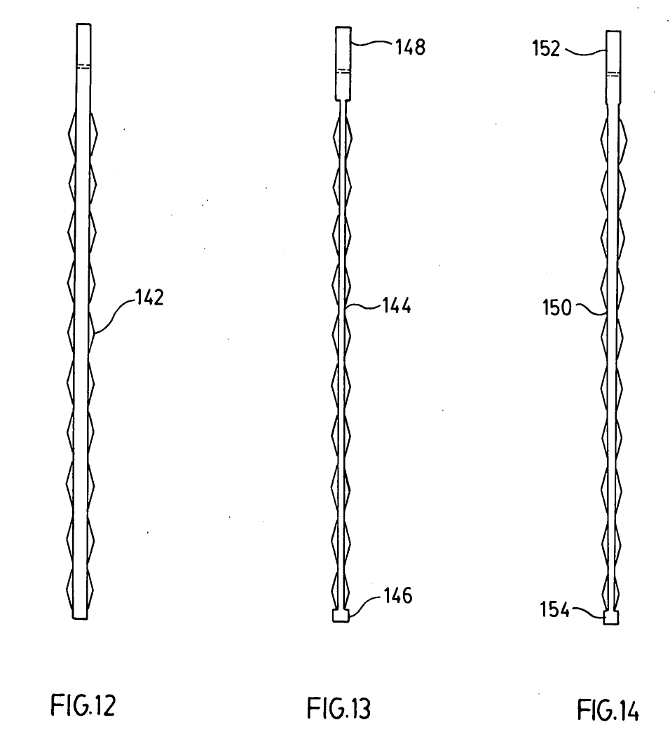

FIG. 12 illustrates a grid having uniformly thick transverse wires 142. FIG. 13 illustrates a lightweight grid having uniformly thin transverse wires 144, with the bottom edge 146 and top edge 148 thickened. FIG. 14 shows a tapered battery grid having thickened top 152 and bottom edge 154 with wires increasing in thickness from the bottom to the top of the grid.

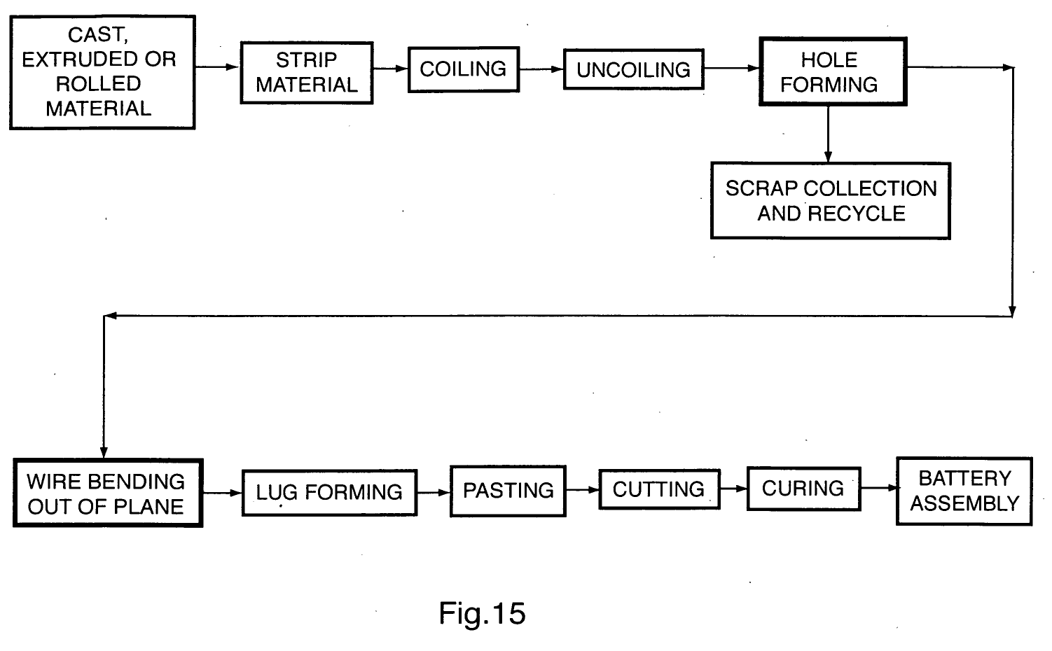

With reference now to FIG. 15, the flowsheet illustrates the method steps of the invention. Cast, extruded or rolled lead or lead alloy strip material, usually coiled, is fed to the hole forming assembly and parallel sets or arrays of grids are formed, such as by punching, along the length of the grid with a longitudinal, central blank section remaining between the sets of grids. The hole forming step is followed by bending of the grid wires out of the plane of the grid, to be described, and forming of grid lugs in the central blank section. The separate grid strips are pasted, severed into discrete battery plates, cured and assembled into battery cases.

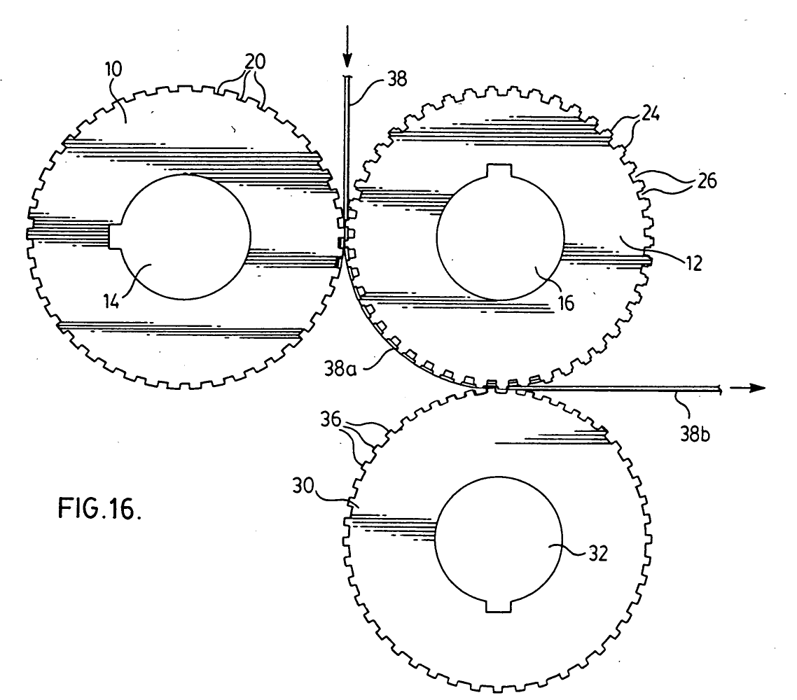

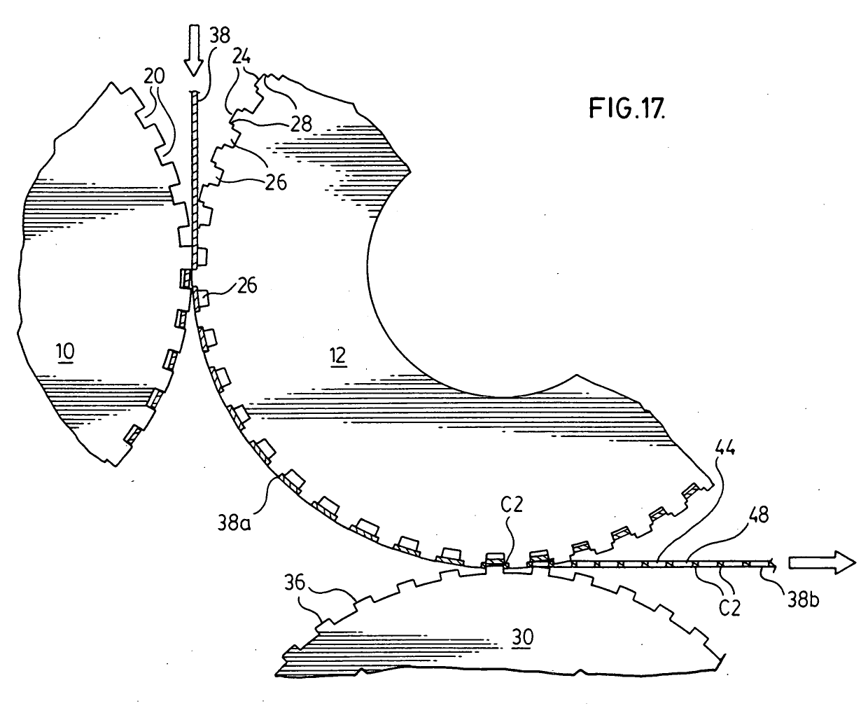

With reference to FIGS. 16-18, a rotary punching apparatus for forming arrays of closely-spaced holes in the strip comprises a first pair of opposed dies 10, 12 mounted for synchronized rotation on shafts 14, 16 respectively in a frame. Although two sets of opposed dies 10, 12 normally are mounted on common shafts and operate in unison on a strip with a longitudinal blank section remaining between two sets of grids for the subsequent forming of lugs, the description herein will proceed with reference to a single set of opposed dies. As shown more clearly in FIGS. 16 and 17, die 10 is a female die keyed on shaft 14 and has transverse rows of angularly equispaced recesses 20 formed on the periphery thereof. Die 12 is a male/female die keyed on drive shaft 16 having transverse rows of angularly equispaced alternating punches 24 and recesses 26 formed on the periphery thereof. Punches 24 are adapted to mate with and fit recesses 20 of die 10. Each punch 24 has a shoulder 28 formed on each side thereof between punch 24 and adjacent recess 26 for reasons which will become apparent as the description proceeds. It will be understood that one, two or more rows of punches and recesses can be used, depending on the requirements of the punched product, as shown in U.S. Pat. No. 7,066,066.

Die 30 mounted for rotation on shaft 32 is a male die keyed on shaft 32 for synchronized rotation with die 12. Male die 30 has angularly equispaced transverse rows of punches 36 adapted to mate with and fit in rows of recesses 26 of die 12 between punch shoulders 28. Although recesses and punches are shown equispaced, the recesses and punches can be spaced as desired for the final product, both angularly about the periphery of the dies and transversely across the width of the dies.

Dies 10, 12 and 30 are driven by anti-lash gears mounted on shafts 14, 16 and 32 respectively.

During rotation of dies 10, 12 and 30, strip 38 guided between dies 10 and 12 is punched in a first stage by sequential insertion of transverse rows of punches 24 on die 12 into transverse rows of mating recesses 20 on die 10. Punch-out material is discharged from female die 10. The strip 38 is keyed onto male/female die 12 by engagement of strip 38 between rows of punches 24 as die 12 rotates to feed strip 38a between male/female die 12 and male die 30. Strip 38a is punched in a second stage, by insertion of rows of punches 36 of male die 30 into mating recesses 26 of male/female die 12 for displacement of punch-out material into recesses 26 between punch shoulders 28 with punched strip 38b discharged from the assembly. Punch-out material is discharged from die 12.

Referring now to the enlarged view of FIGS. 17, punches 24 of male/female die 12 are adapted to be inserted into opposed recesses 20 of female die 10 as the dies rotate. In like manner, punches 36 of male die 30 are adapted to be inserted into opposed recesses 26 of male/female die 12 between shoulders 28 of punches 24 as the dies rotate.

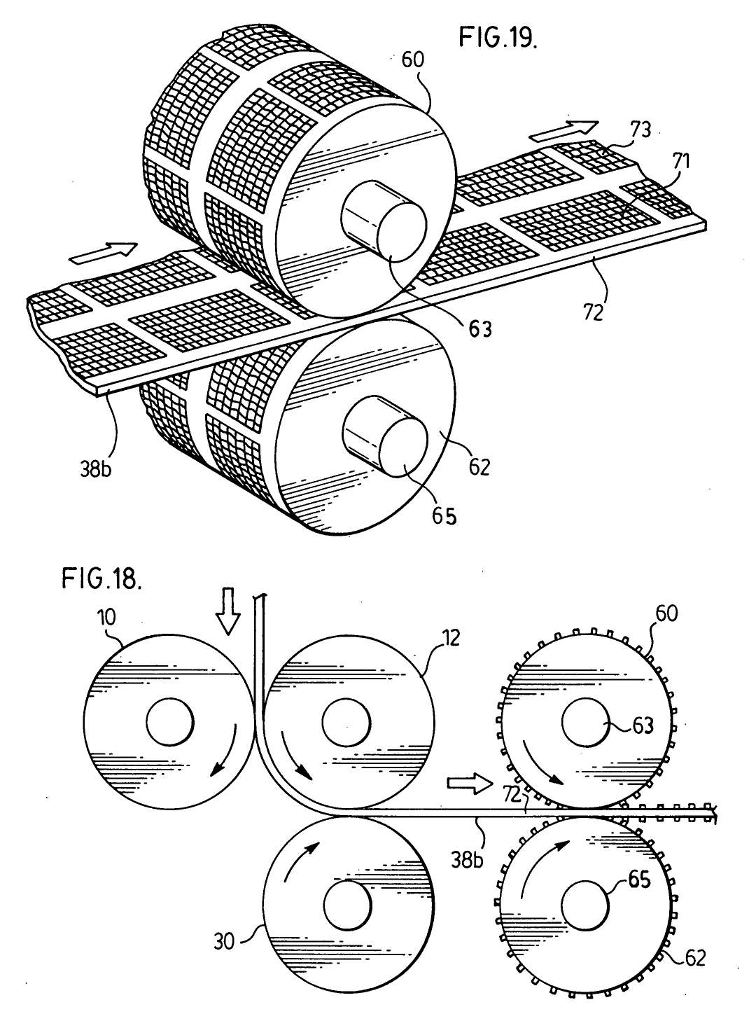

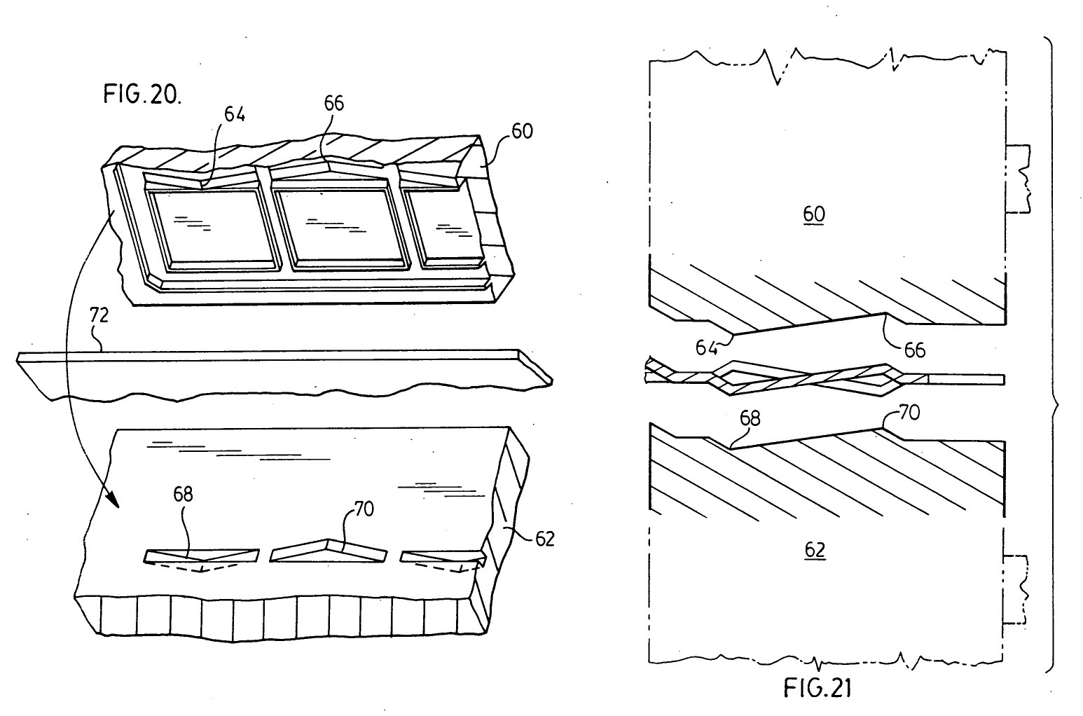

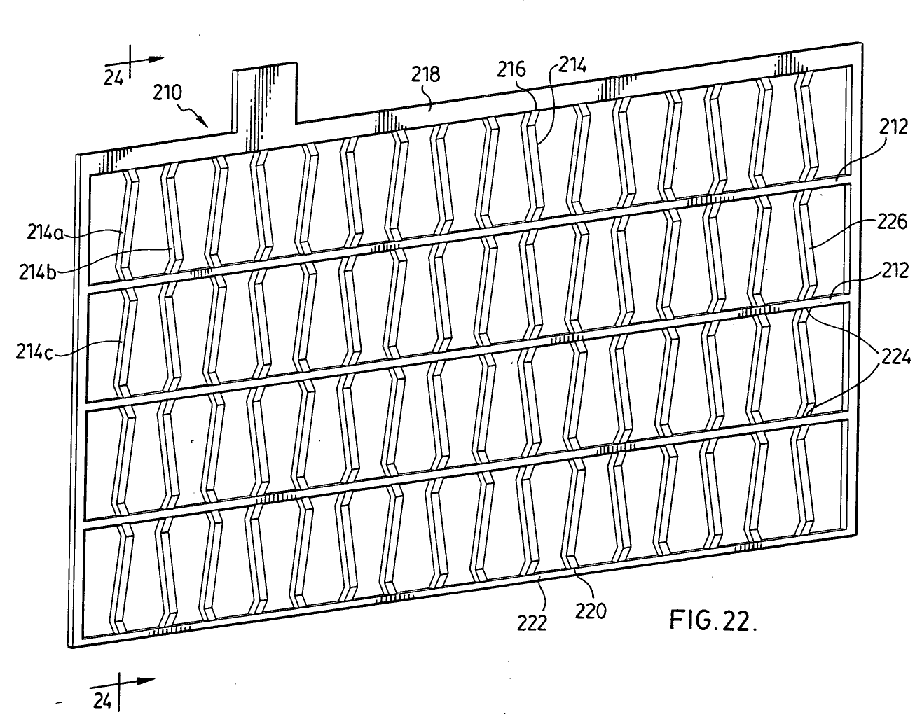

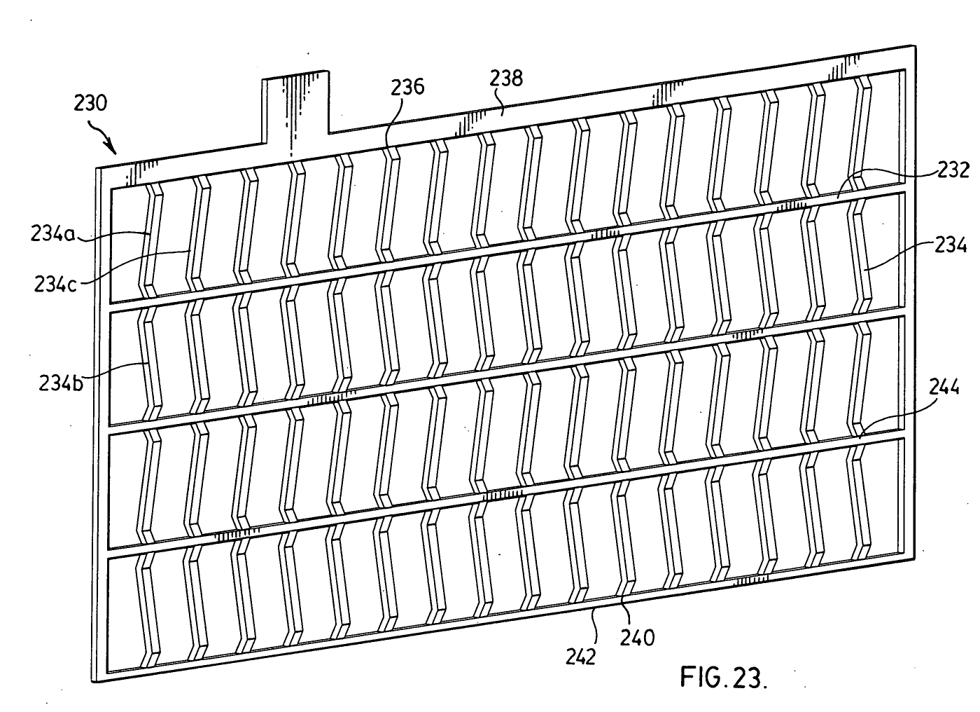

With reference to FIGS. 18 and 19, perforated strip 38b from opposed rolls 12, 30 passes to opposed rolls 60, 62 mounted on shafts 63, 65 respectively having angularly-spaced alternating projections 64 and recesses 66 of roll 60 mating with recess 68 and projections 70 of roll 62, shown most clearly in FIGS. 20 and 21, to bend the transverse grid wires 71 symmetrically out of the plane of the strip as depicted by strip 72. Opposed rolls 60, 62 bend a parallel set of grids 73, shown partly cut away for illustration purposes. Projections 64 and recesses 60 and mating recesses 68 and projections 70 are shaped to produce desired grid wire configurations as shown in FIGS. 1, 8, 10-14 and 22, 23 to be described. Alternating transverse grid wires can be bent sequentially out of the plane of both sides of the grid in opposite directions along the length of the grid, across the width of the grid, or both along the length and across the width of the grid. The angle a at which the grid wire is bent out of the plane of the grid in proximity to the nodes and the grid edges is at least 5°, preferably in the range of 5° to 45° and more preferably in the range of 15° to 35°. The grid wires project at least 0.1 millimetre out of the plane of the grid on each side of the grid, up to the thickness of the grid, for a total thickness of up to three times of the thickness of the starting grid material.

After bending the grid wires out of plane, the formed strip is passed to the lug-forming step and then pasted, cut, cured and assembled into battery cases.

FIGS. 22-26 illustrate two preferred embodiments of grids of the present invention. FIGS. 22-24 show a battery grid 210 having longitudinal grid wires 212 and transverse grid wires 214, attached at 216 to longitudinal side edge 218, at 220 to longitudinal side edge 222, and to longitudinal wires 212 at nodes 224. Transverse wires 214 are bent in proximity to side edges 218 and 222 and at nodes 224 at an angle of about 20° to the plane of grid 210 in a preferred range of 15° to 35°, projecting about 0.4 millimetre out of the plane of the grid on each side of the grid, for a total of 1.6 millimetres for a grid having a starting thickness of 0.8 millimetre with a central connecting wire section 226 passing through the plane of the grid. FIG. 22 illustrates alternating transverse grid wires 214a and 214b bent in opposite directions out of the plane of the grid along the length of the grid, and alternating grid wires 214a and 214c bent in the same direction out of the plane of the grid across the width of the grid. It will be understood that the alternating grid wires 214a and 214c across the width of the grid could also be bent in opposite direction.

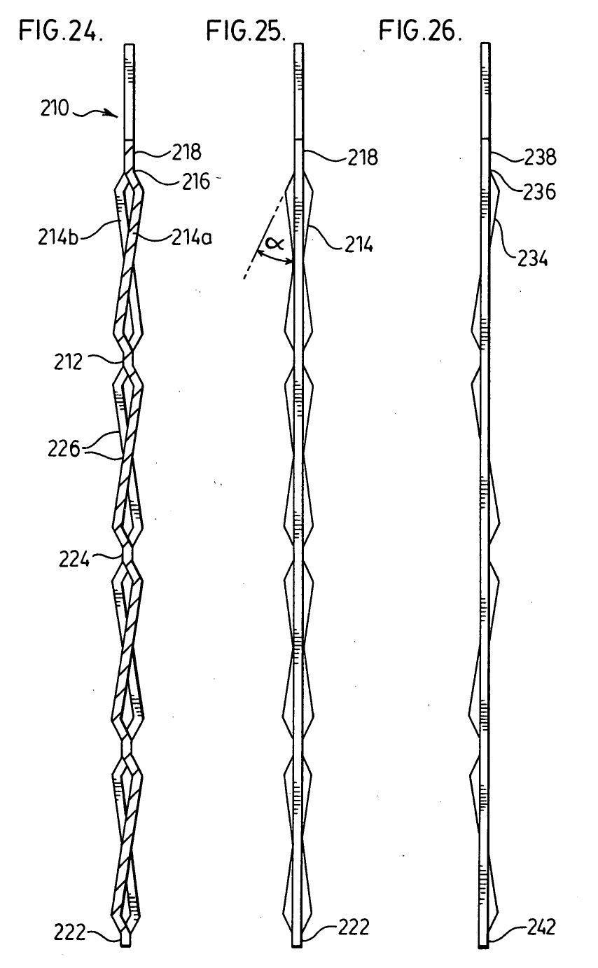

FIGS. 24, 25 show a battery grid 230 having longitudinal grid wires 232 and transverse grid wires 234 attached at 236 to longitudinal side edge 238, at 240 to longitudinal side edge 242, and to longitudinal wires 232 at nodes 244. Alternating transverse wires 234a and 234b are bent in opposite directions out of the plane of the grid across the width of the grid, and alternating wires 234a and 234c are bent in the same direction out of the plane of the grid along the length of the grid.

It has been found that the embodiments of FIGS. 22-25 provide good lateral resistance to deformation back into the plane of the grid during pasting. Tests conducted on 100 pairs of battery plates having the grid of FIG. 22 in a commercial battery plant with cured tri-basic lead sulphate paste indicated very good adhesion after a flash cure but before the final cure. A typical paste was used in a standard positive plate production run using a Barton pot lead oxide as the starting material. Paste density was 4.1 g/cc. The grid was Pb—Ca—Sn—Ag alloy typically used in a North American SLI battery production plant.

It will be understood that other embodiments and examples of the invention will be readily apparent to a person skilled in the art, the scope and purview of the invention being defined in the appended claims.

1. A method of making battery grids for supporting battery paste comprising:
providing a length of lead alloy strip having a width defined by a pair of equispaced side edges;
forming an elongated array of closely-spaced holes in the strip defining a grid having a plurality of equispaced longitudinal grid wires parallel to the strip side edges across at least a portion of the width of the lead alloy strip and a plurality of transverse grid wires extending across the grid from one side to the other side of the grid intersecting the longitudinal grid wires at nodes, and bending the grid wires intermediate the nodes out of the plane of the grid for enhanced paste retention to the grid.

2. A method as claimed in claim 1, wherein the transverse grid wires are bent out of the plane of the grid symmetrically about the plane of the grid.

3. A method as claimed in claim 2, wherein the transverse grid wires are bent out of the plane of the grid in proximity to the grid sides and in proximity to the nodes.

4. A method as claimed in claim 3, wherein alternating transverse grid wires are bent in opposite directions out of the plane of the grid along the length of the grid.

5. A method as claimed in claim 3, wherein alternating transverse grid wires are bent in opposite directions out of the plane of the grid across the width of the grid.

6. A method as claimed in claim 3, wherein alternating transverse grid wires are bent in opposite directions out of the plane of the grid along the length of the grid and across the width of the grid.

7. A method as claimed in claim 3, wherein the transverse grid wires are bent out of the plane of the grid at an angle of at least about 5° to the plane of the grid.

8. A method as claimed in claim 3, wherein the transverse grid wires are bent out of the plane of the grid at an angle of about 5° to 45° to the plane of the grid.

9. A method as claimed in claim 7, wherein the transverse grid wires are bent out of the plane of the grid at least 0.1 millimetre up to the thickness of the grid from each side of the grid for a total thickness of up to three times the thickness of the grid.

10. A method as claimed in claim 1, wherein the strip is produced by casting, extruding or rolling lead or lead alloy.

11. A method as claimed in claim 10, wherein the strip has a controlled profile for producing thin, lightweight or tapered battery grids.

12. A method as claimed in claim 1, in which the array of closely-spaced holes are formed in the strip by punching strip material out of the lead alloy strip by a first pair of opposed rotary dies consisting of a female die and a male/female die and a second pair of opposed rotary dies consisting of a said male/female die and a male die comprising continuously feeding the length of strip to the first pair of opposed rotary dies for punching a first set of closely-spaced holes transversely of the strip along the strip, continuously feeding the strip to the second pair of dies for punching a second set of holes in the strip between the first set of holes defining the grid having grid wires, the strip being wrapped about the common male/female die during punching of the first and second sets of holes to continuously index the strip with the two opposed pairs of rotary dies to ensure production of higher-tolerance closely-spaced holes, and bending the grid wires out of the plane of the grid.

13. A method as claimed in claim 12, wherein the transverse grid wires are bent symmetrically out of the plane of the grid by passing the strip through a pair of opposed rolls having angularly-spaced alternating projections and recesses of one roll for mating with angularly-spaced alternating recesses and projections of the other roll, whereby the transverse grid wires are displaced into the recesses of the rolls for bending of the transverse grid wires out of the plane of the grid.

14. A method as claimed in claim 13, wherein the transverse grid wires are bent symmetrically out of the plane of the grid in proximity to the grid side edges and in proximity to the nodes.

15. A method as claimed in claim 14, wherein alternating transverse grid wires are bent in opposite directions out of the plane of the grid along the length of the lead alloy strip.

16. A method as claimed in claim 14, wherein alternating transverse grid wires are bent in opposite directions out of the plane of the grid across the width of the lead alloy strip.

17. A method as claimed in claim 14, wherein alternating transverse grid wires are bent in opposite directions out of the plane of the grid along the length of the grid and across the width of the grid.

18. A method as claimed in claim 14, wherein the transverse grid wires are bent out of the plane of the grid at an angle of at least about 5° to the plane of the grid.

19. A method as claimed in claim 14, wherein the transverse grid wires are bent out of the plane of the grid at an angle of about 5° to 45° to the plane of the grid.

20. A method as claimed in claim 14, wherein the transverse grid wires are bent out of the plane of the grid up to at least 0.1 millimetre up to the thickness of the grid from each side of the grid for a total thickness up to three times the thickness of the grid.

21. A method as claimed in claim 1, forming a lug in the strip adjacent one side of the grid, and wherein the lead alloy strip is tapered from a longitudinal side edge remote from the lug towards the lug whereby electrical conductivity is enhanced in proximity to the lug.

22. A method as claimed in claim 20, wherein the length of lead alloy strip has a thin central section and thickened longitudinal side edges.

23. A method as claimed in claim 21, wherein transverse grid wires have an increasing width from the longitudinal side edge remote from the lug towards the lug.

24. A method of making battery plates comprising:
providing a length of lead alloy strip having a width defined by a pair of equispaced side edges;
forming equispaced elongated arrays of closely-spaced holes in the strip defining grids having a plurality of equispaced longitudinal grid wires parallel to the side edges across at least a portion of the width of the lead alloy strip and a plurality of transverse grid wires extending across the grid and intersecting the longitudinal grid wires at nodes, and bending the grid wires intermediate the nodes out of the plane of the grid for enhanced paste retention to the grid;
applying paste to the grids formed in the lead alloy strip, and
cutting the pasted strip to form pasted battery plates.

25. A method as claimed in claim 24, wherein the transverse grid wires are bent out of the plane of the grid at an angle of at least about 5° to the plane of the grid in proximity to the grid sides and in proximity to the nodes.

26. A method as claimed in claim 24, wherein the transverse wires are bent out of the plane of the grid at least 0.1 millimetre up to the thickness of the grid at an angle of about 5° to 45° to the plane of the grid.

27. A method of making battery plates as claimed in claim 26, forming a pair of elongated parallel arrays of closely-spaced holes in the strip, each array of holes defining a said grid in proximity to a strip side edge separated from an adjacent grid by a longitudinal, central blank section,
forming grid lugs in the central blank section,
applying paste to the grids, and
severing the pasted grids into battery plates.

28. A method as claimed in claim 27, wherein the transverse wires are bent 0.4 millimetre out of the plane of the grid from each side of the grid at an angle to the grid in the range of 15° to 35°.

29. A method as claimed in claim 27, wherein the transverse wires are bent 0.4 millimetre out of the plane of the grid from each side of the grid at an angle to the grid of about 20°.

30. Battery plates made according to the method of claim 27.

31. Battery plates made according to the method of claim 28.
